(19) United States
(12) Patent Application Publication
(10) Pub. No.: US 2017/0318882 A1
(43) Pub. Date: Nov. 9, 2017

(54) METHOD OF MANUFACTURING DECORATIVE FLOWER

(71) Applicant: Se Yong OH, Chungcheongnam-do (KR)

(72) Inventor: Se Yong OH, Chungcheongnam-do (KR)

(21) Appl. No.: 15/252,861

(22) Filed: Aug. 31, 2016

(30) Foreign Application Priority Data
May 4, 2016 (KR) 10-2016-0055748

(51) Int. Cl. A41G 1/00; C09J 5/04

(52) U.S. Cl. CPC A41G 1/00; C09J 5/04

(57) ABSTRACT

Provided herein as a method of manufacturing a decorative flower, including forming a stem by cutting a leather sheet into two rectangular stem leather pieces and adhering the rear surfaces of the stem leather pieces to each other using an adhesive, folding a petal leather piece by cutting a leather sheet into the rectangular petal leather piece, applying the adhesive to first adhesive surfaces of the petal leather piece and folding the petal leather piece in half in the horizontal direction, making cuts in the petal leather piece in the vertical direction at designated intervals, applying the adhesive to a second adhesive surface of the petal leather piece and rolling the petal leather piece into a cylindrical shape about the stem, forming petals by spreading parts formed by the cuts, and decorating the lower portion of the stem leather piece with a running stitch after formation of the petals.

### CROSS-REFERENCE TO RELATED APPLICATIONS

This application claims the priority of benefit to Korean patent application No. 10-2016-0055748 filed on May 4, 2016, the entire contents of which is hereby incorporated by reference.

### BACKGROUND OF THE INVENTION

### Field of the Invention

The present invention relates to leather craft and, more particularly, to a method of manufacturing a decorative flower in which a plurality of cuts is made in leather so as to manufacture petals.

### Description of the Related Art

A corsage means a bunch of real flowers or artificial flowers fastened to decorate the front portion of a woman's dress, such as a shoulder or a waistline, at events, such as a wedding ceremony.

Corsages are usually manufactured by handcraft, and more particularly, manufactured using real flowers or manufactured as a bundle of artificial flowers using various materials, such as silk, fabrics, leathers, meshes, feathers, plastics, jewelry, etc. Recently, corsages tend to be used as fashion accessories, being used in bags, hats, wallets, shoes, etc. in addition to being used in clothes, and to be easily stored.

In general, ornaments having various shapes, formed of fabrics or leathers, are attached to clothes, bags, etc. and, particularly, among these ornaments, there are many flower ornaments having flower shapes.

Such a flower ornament generally includes a stamen unit having a stamen shape and formed at the center of the flower ornament, and a petal unit disposed to surround the stamen unit, thus forming an overall flower shape. The stamen unit and the petal unit are formed by separate sheets respectively formed of fabrics or leathers and, particularly, the petal unit is generally formed by respectively fixing a plurality of sheets, cut into a petal shape, along the circumference of the stamen unit one by one.

However, in the case of such a conventional flower ornament, manufactured through the above method in which a large number of sheets are attached one by one, a man-hour is increased and manufacture of the flower ornament is difficult, thus limiting mass-production of the flower ornament.

In order to solve the above problems, Korean Patent Registration No. 10-0393346 (Jul. 21, 2003) proposes a decorative fur corsage of a designated shape, which is manufactured by cutting fur so as to be attached to clothes, belongings, accessories, etc., to decorate the clothes, belongings, accessories, etc. A method of manufacturing the decorative fur corsage includes dying a fur sheet with a desired color and then cutting the fur sheet into a size having a designated width and a designated length, folding the cut fur piece in half in the width direction such that a leather part faces inward and a fur part faces outward and then sawing the front end of the folded fur piece through an overlock so as to make a fur band having a sewing line, and rolling the fur band based on the front end of one side located in any direction except for the sewing line.

However, the proposed conventional technique only discloses the method of manufacturing the decorative fur corsage only including a process of cutting the fur sheet, folding the cut fur piece in half and then rolling the fur piece, but does not state a method of manufacturing a corsage having a petal shape.

### SUMMARY OF THE INVENTION

Therefore, the present invention has been made in view of the above problems, and it is an object of the present invention to provide a method of manufacturing a decorative flower and, more particularly, to a method of manufacturing a petal-shaped corsage in which a leather piece folded in half and provided with a plurality of cuts is rolled into a cylindrical shape about a leather piece for a stem.

In accordance with an aspect of the present invention, the above and other objects can be accomplished by the provision of a method of a decorative flower including forming a stem by cutting a leather sheet into two rectangular leather pieces having a size of 29 cm in the horizontal direction and 0.75 cm in the vertical direction (hereinafter, referred to as “stem leather pieces”), applying an adhesive to the rear surfaces of the cut stem leather pieces and adhering the rear surfaces of the stem leather pieces to each other so as to overlap each other, folding a petal leather piece by cutting a leather sheet into a rectangular leather piece having a size of 25 cm in the horizontal direction and 9 cm in the vertical direction (hereinafter, referred to as “the petal leather piece”), applying the adhesive to first adhesive surfaces of the petal leather piece and then folding the petal leather piece in half in the horizontal direction such that the first adhesive surfaces are adhered to each other, making cuts between the first adhesive surfaces formed on the upper and lower portions of the petal leather piece in the vertical direction at intervals of 4 mm, applying the adhesive to a second adhesive surface of the petal leather piece provided with the cuts, rolling the petal leather piece into a cylindrical shape about a designated position of the lower end of the stem and then sewing the end of the adhesive part of the second adhesive surface, forming petals by spreading parts formed by the cuts so that the upper portion of the cylindrically rolled petal leather piece forms petal shapes, and decorating the lower portion of the stem with a running stitch after formation of the petals.

In accordance with another aspect of the present invention, there is provided a method of manufacturing a decorative flower including forming a stem by cutting a leather sheet into two stem leather pieces having a size of 29 cm in the horizontal direction and 0.75 cm in the vertical direction, applying an adhesive to the rear surfaces of the cut stem leather pieces and adhering the rear surfaces of the stem leather pieces to each other so as to overlap each other, cutting a leather sheet into a petal leather piece having a size of 25 cm in the horizontal direction and 9 cm in the vertical direction and making cuts between first adhesive surfaces formed on the upper and lower portions of the petal leather piece in the vertical direction at intervals of 4 mm, folding a petal leather piece by applying the adhesive to the first adhesive surfaces of the petal leather piece and then folding the petal leather piece in half in the horizontal direction such that the first adhesive surfaces are adhered to each other, applying the adhesive to a second adhesive surface of the petal leather piece provided with the cuts, rolling the petal leather piece into a cylindrical shape about a designated position of the lower end of the stem and then sewing the end of the adhesive part of the second adhesive surface, forming petals by spreading parts formed by the cuts so that the upper portion of the cylindrically rolled petal leather piece forms petal shapes, and decorating the lower portion of the stem with a running stitch after formation of the petals.

In making the cuts between first adhesive surfaces formed on the upper and lower portions of the petal leather piece in the vertical direction, the cuts may be made in the petal leather piece in an oblique direction rather than the vertical direction.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart of a process of manufacturing a decorative flower in accordance with one embodiment of the present invention;

FIGS. 2A to 2H are exemplary views illustrating a process of manufacturing petals in accordance with one embodiment of the present invention;

FIGS. 3A to 3E are exemplary views illustrating a process of manufacturing a stem in accordance with one embodiment of the present invention;

FIGS. 4A to 4E are exemplary views illustrating a process of combining the petals with the stem; and

FIGS. 5A to 5C are exemplary views illustrating various applications of a decorative flower manufactured in accordance with one embodiment of the present invention.

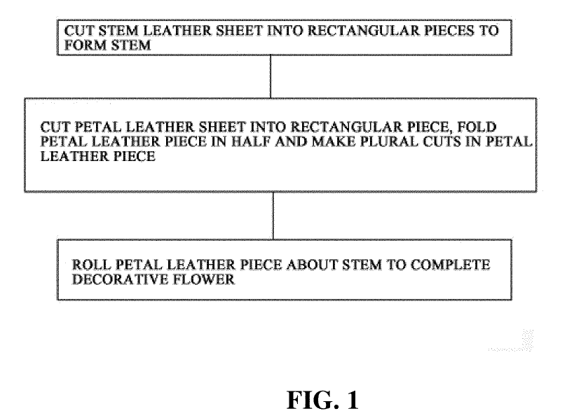

### DETAILED DESCRIPTION OF THE INVENTION

Hereinafter, embodiments of the present invention will be described with reference to the annexed drawings.

In the following description of the present invention, a detailed description of known functions and configurations incorporated herein will be omitted when it may make the subject matter of the present invention rather unclear.

As a material for manufacturing a decorative flower of the present invention, leathers, fabrics, etc. may be used and in embodiments of the present invention, it will be assumed that leathers are used.

A method of a decorative flower in accordance with one embodiment of the present invention includes forming a stem by cutting a leather sheet into two rectangular leather pieces having a size of 29 cm in the horizontal direction and 0.75 cm in the vertical direction (hereinafter, referred to as “stem leather piece ”), applying an adhesive to the rear surfaces of the cut stem leather pieces and adhering the rear surfaces of the stem leather pieces to each other, folding a petal leather piece by cutting a leather sheet into a rectangular leather piece having a size of 25 cm in the horizontal direction and 9 cm in the vertical direction (hereinafter, referred to as “the petal leather piece”), applying the adhesive to first adhesive surfaces of the petal leather piece and then folding the petal leather piece in half in the horizontal direction such that the first adhesive surfaces are adhered to each other, making cuts between the first adhesive surfaces formed on the upper and lower portions of the petal leather piece in the vertical direction at intervals of 4 mm, applying the adhesive to a second adhesive surface of the petal leather piece provided with the cuts, rolling the petal leather piece into a cylindrical shape about a designated position of the lower end of the stem and then sewing the end of the adhesive part of the second adhesive surface, forming petals by spreading parts formed by the cuts so that the upper portion of the cylindrically rolled petal leather piece forms petal shapes, and decorating the lower portion of the stem with a running stitch after formation of the petals.

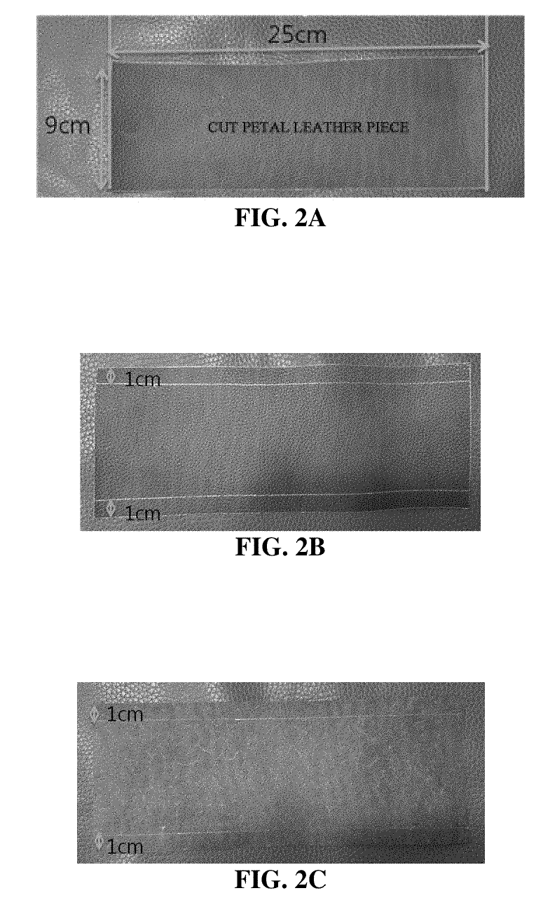

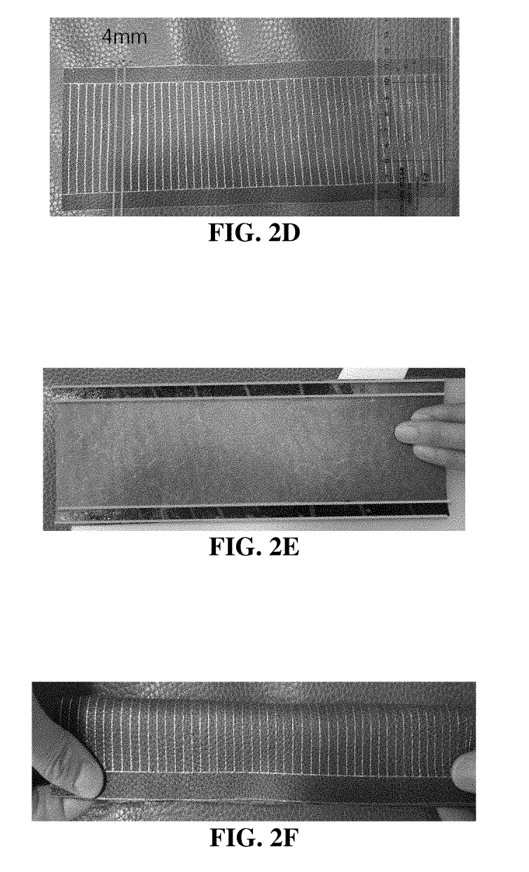

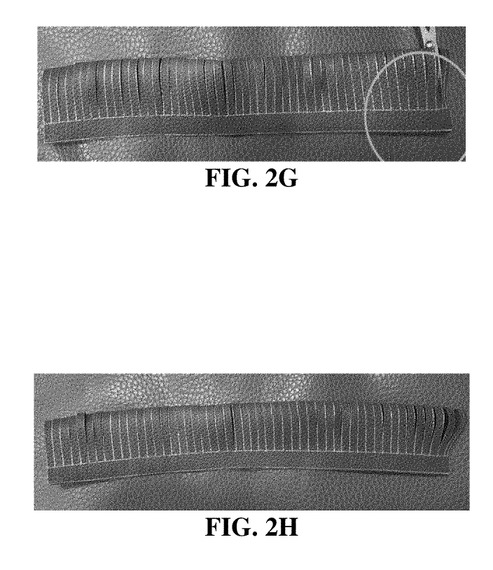

The above-described operation in accordance with the embodiment of the present invention will be described in more detail with reference to FIGS. 2A to 5C.

1) Cutting of Leather for Stem

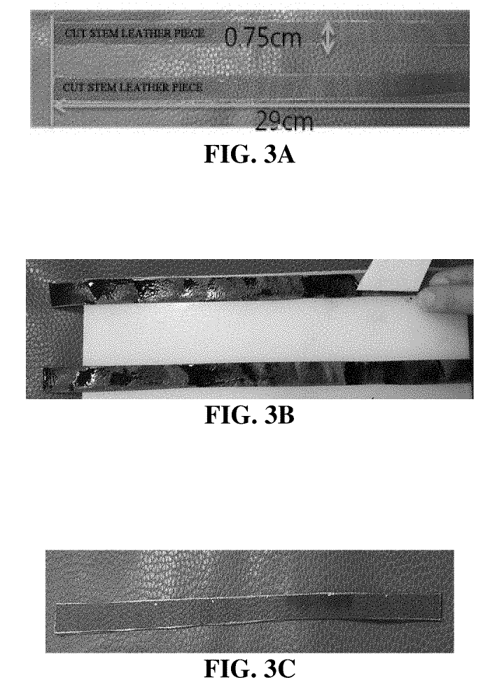

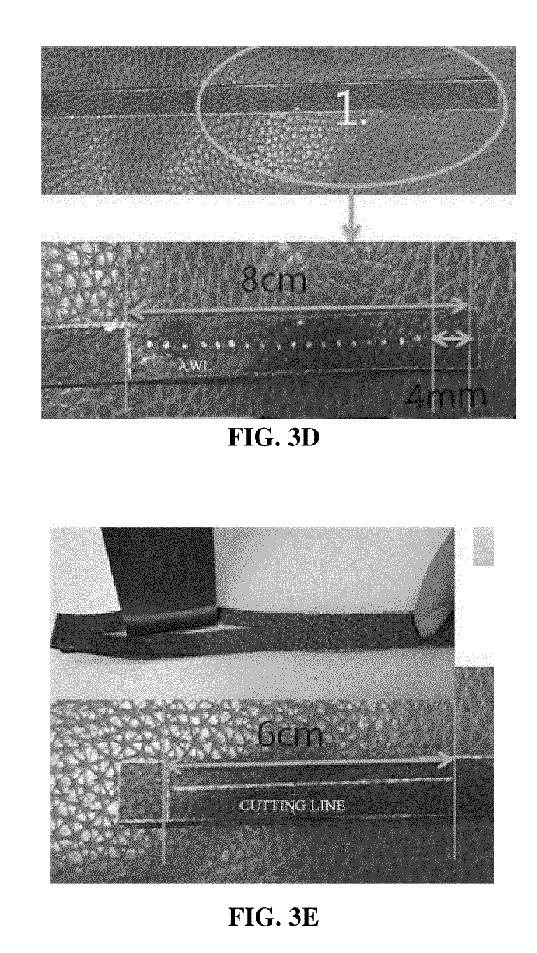

Two stem leather pieces having a size of 29 cm in the horizontal direction and 0.75 cm in the vertical direction are prepared by cutting a leather sheet, as exemplarily shown in FIG. 3A, and, after an adhesive is applied to the rear surfaces of the two stem leather pieces, the rear surfaces of the two stem leather pieces opposite each other are adhered to each other, as exemplarily shown in FIG. 3B, thereby manufacturing a stem, as exemplarily shown in FIG. 3C.

Holes are formed through the manufactured stem at intervals of 2 mm from the lower end of the stem to a position 8 cm from the lower end of the stem, as exemplarily shown in FIG. 3D. Further, a cutting line of 6 cm in the horizontal direction is formed at a position 1 cm from the upper end of the stem and a cut is made along the cutting line, as exemplarily shown in FIG. 3E.

Thereby, manufacture of the stem is completed.

2) Cutting of Leather for Petals

A petal leather piece having a size of 25 cm in the horizontal direction and 0.75 cm in the vertical direction is prepared by cutting a leather sheet, as exemplarily shown in FIG. 2A.

A line is drawn in the horizontal direction at a position 1 cm from each of the upper and lower ends of the front surface of the petal leather piece with a pen, as exemplarily shown in FIG. 2B. Further, a line is drawn in the horizontal direction at a position 1 cm from each of the upper and lower ends of the rear surface of the petal leather piece with the pen, as exemplarily shown in FIG. 2C.

Lines are drawn in the vertical direction at intervals of 4 mm between the horizontal lines drawn at the positions of 1 cm from the upper and lower ends of the petal leather piece, as exemplarily shown in FIG. 2D.

The adhesive is applied to first adhesive surfaces formed in areas up to 1 cm from the upper and lower ends of the petal leather piece, as exemplarily shown in FIG. 2E, and then the petal leather piece is folded in half in the horizontal direction such that the first adhesive surfaces are adhered to each other so as to overlap each other, as exemplarily shown in FIG. 2F.

The petal leather piece, folded in half in the horizontal direction such that the first adhesive surfaces are adhered to each other, is regularly cut along the lines drawn in the vertical direction at intervals of 4 mm using leather cutting scissors, as exemplarily shown in FIG. 2G, thereby completing manufacture of petals, as exemplarily shown in FIG. 2H.

3) Completion of Flower By Rolling Petals About Stem

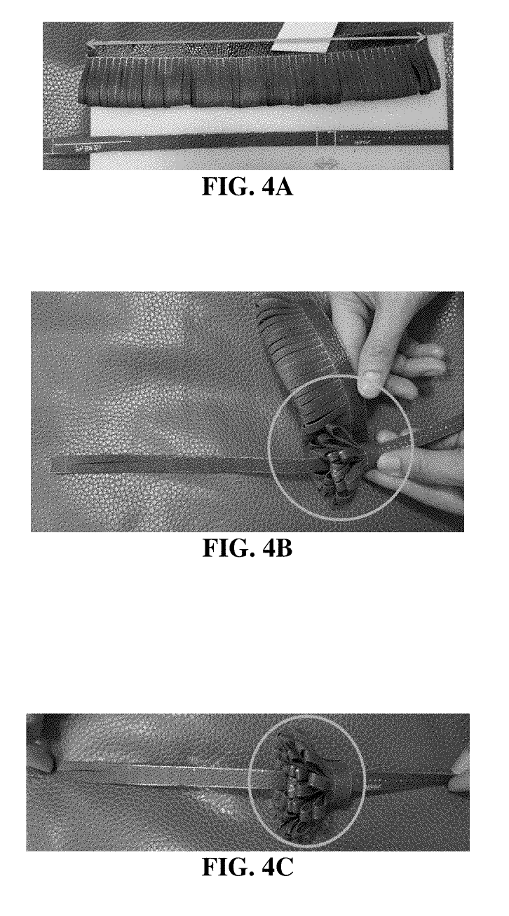

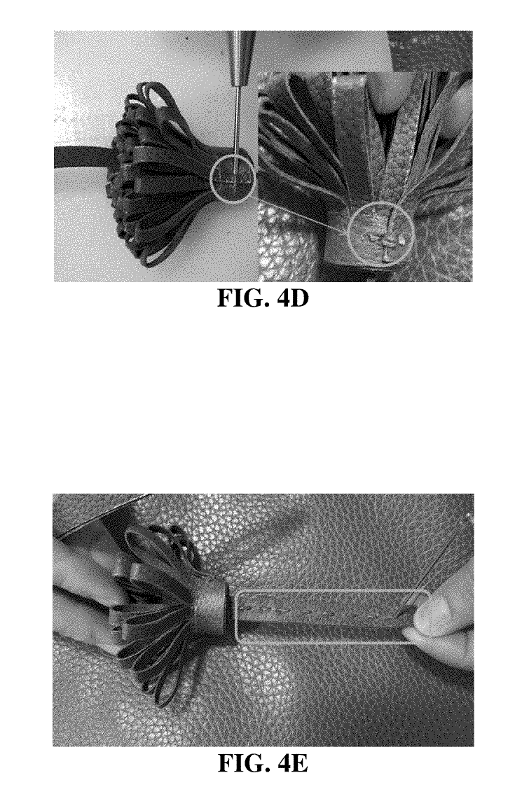

The adhesive is applied to a second adhesive surface corresponding to an area up to 1 cm from the upper end of the petal leather piece manufactured in FIG. 2H, as exemplarily shown in FIG. 4A. Further, the adhesive is applied to the front and rear sides of a third adhesive surface corresponding to an area up to 1 cm from a position separated from the lower end of the stem by 8 cm.

Thereafter, as exemplarily shown in FIG. 4B, after one end of the second adhesive surface of the petal leather piece, to which the adhesive is applied, is adhered to the third adhesive surface of the stem, the petal leather piece is regularly rolled into a cylindrical shape, thereby being adhered to the stem, as exemplarily shown in FIG. 4C.

4) Interconnection of Seam Part of Petal Leather Piece with Colored Thread

A hole is formed through a seam part of the other end of the cylindrically rolled petal leather piece and then the seam part is sewed 2 to 3 times with a colored thread so as to prevent the petal leather piece from being unrolled from the stem, as exemplarily shown in FIG. 4D.

Thereafter, the holes formed through the lower end of the stem at intervals of 2 mm are decorated with a colored thread, as exemplarily shown in FIG. 4E. Here, as such a decoration of the stem, a running stitch may be used.

5) Various Applications of Completed Decorative Flower

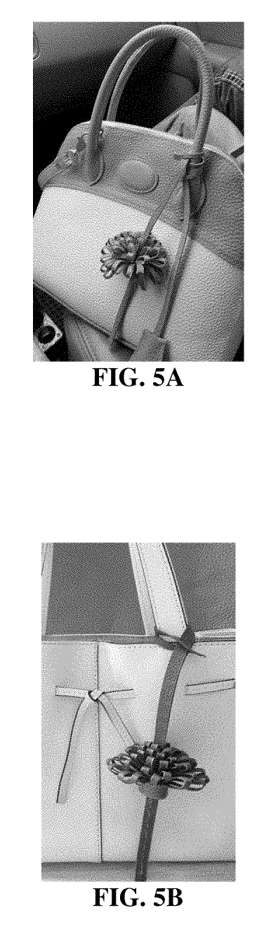

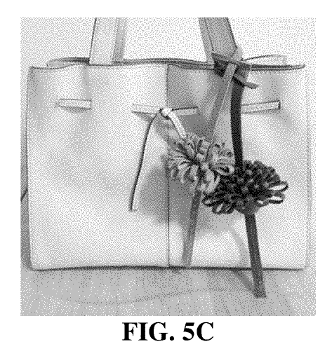

A decorative flower completed through the above process may be variously applied to decorate items, as exemplarily shown in FIGS. 5A to 5C.

In general, accessories for leather bags are manufactured to have the theme “Queen's Leather Flower (G.L.F.)” based on the value of that “Leather should be treated with leather”, thus meaning that a queen is always newly reborn with rainbow colors everyday for a week.

The decorative flower in accordance with the present invention images the shape of a flower using a pastel-colored high-quality leather. Particularly, a rainbow-colored leather flower may be commercialized, thereby contributing to improvement of the image of a product.

Although the above-described embodiment describes the process in which a plurality of cuts is made in the petal leather piece after the first adhesive surfaces are adhered to each other by folding the petal leather piece in half, a process in which a plurality of cuts is made in the petal leather piece before folding of the petal leather piece in half and then the first adhesive surfaces are adhered to each other by folding the petal leather piece in half may be executed.

Further, in the above process, although the cuts are made in the petal leather piece in the vertical direction, cuts may be formed in the petal leather piece in an oblique direction rather than the vertical direction, thereby varying the form of the decorative flower.

As apparent from the above description, a method of manufacturing a decorative flower in accordance with the present invention may provide effects as below.

First, after cuts are made in a leather piece, the leather piece is rolled into a cylindrical shape to manufacture petal shapes, thereby easily mass-producing decorative flowers.

Second, a cutting method of leather sheets, a cut making method and a process order may vary, thereby manufacturing various types of decorative flowers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of manufacturing a decorative flower, comprising:
forming a stem by cutting a leather sheet into two rectangular stem leather pieces, applying an adhesive to the rear surfaces of the stem leather pieces and adhering the rear surfaces of the stem leather pieces to each other so as to overlap each other;
folding a petal leather piece by cutting a leather sheet into the rectangular petal leather piece, applying the adhesive to first adhesive surfaces of the petal leather piece and folding the petal leather piece in half in the horizontal direction such that the first adhesive surfaces are adhered to each other;
making cuts between the first adhesive surfaces formed on the upper and lower portions of the petal leather piece in the vertical direction at designated intervals;
applying the adhesive to a second adhesive surface of the petal leather piece provided with the cuts and rolling the petal leather piece into a cylindrical shape about a designated position of the lower end of the stem; and
forming petals by spreading parts formed by the cuts so that the upper portion of the cylindrically rolled petal leather piece forms petal shapes.

2. The method according to claim 1, further comprising decorating the lower portion of the stem, after formation of the petals.

3. The method according to claim 1, in which the cuts are made in the petal leather piece in an oblique direction rather than the vertical direction.

4. A method of manufacturing a decorative flower, comprising:
forming a stem by cutting a leather sheet into two rectangular stem leather pieces, applying an adhesive to the rear surfaces of the stem leather pieces and adhering the rear surfaces of the stem leather pieces to each other so as to overlap each other;
cutting a leather sheet into a rectangular petal leather piece and making cuts between first adhesive surfaces formed on the upper and lower portions of the petal leather piece in the vertical direction at designated intervals;
folding the petal leather piece by applying the adhesive to the first adhesive surfaces of the petal leather piece and folding the petal leather piece in half in the horizontal direction such that the first adhesive surfaces are adhered to each other;
applying the adhesive to a second adhesive surface of the petal leather piece provided with the cuts and rolling the petal leather piece into a cylindrical shape about a designated position of the lower end of the stem; and
forming petals by spreading parts formed by the cuts so that the upper portion of the cylindrically rolled petal leather piece forms petal shapes.

5. The method according to claim 4, further comprising decorating the lower portion of the stem, after formation of the petals.

6. The method according to claim 4, in which the cuts are made in the petal leather piece in an oblique direction rather than the vertical direction.
